(19) United States
(12) Patent Application Publication
(10) Pub. No.: US 2020/0104173 A1
(43) Pub. Date: Apr. 2, 2020

(54) COMMUNICATION PROCESS LOAD BALANCING IN AN AUTOMATION ENGINE

(71) Applicant: CA Software Österreich GmbH, Wien (AT)

(72) Inventors: Andreas Ronge, Reichersdorf (AT); Johann Niederer, Frankenfels (AT)

(73) Assignee: CA Software Österreich GmbH, Wien (AT)

(21) Appl. No.: 16/164,641

(22) Filed: Oct. 18, 2018

Related U.S. Application Data
(60) Provisional application No. 62/739,188, filed on Sep. 29, 2018.

(51) Int. Cl. G06F 9/50; G06Q 10/06; G06F 9/48

(52) U.S. Cl. CPC G06F 9/5005; G06F 9/4806; G06Q 10/0631

(57) ABSTRACT

A connection request is received from an agent at a particular one of multiple communication processes of an automation engine, for the agent to connect to the automation engine through the particular communication process. The agent is to act as one of multiple agents configured to perform automation actions at the direction of the automation engine system, where communication between the automation engine and the agents is facilitated through the communication processes. A number of connections at each of the communication processes is determined and a threshold value is identified. The particular communication process determines that connecting the particular agent to the particular communication process would cause the number of connections at the particular communication process to violate the threshold. The particular communication process causes the particular agent to instead connect to another one of the communication processes of the automation engine based on the threshold.

### RELATED APPLICATION

This application claims benefit to U.S. Provisional Patent Application Ser. No. 62/739,188, filed Sep. 29, 2018 and incorporated by reference herein in its entirety.

### BACKGROUND

The present disclosure relates in general to the field of computing systems, and more specifically, to automation of software tools in computing systems.

Modern software systems often include multiple programs or applications working together to accomplish a task or deliver a result. An enterprise can maintain several such systems. Further, development times for new software releases are shrinking allowing releases to be deployed to update or supplement a system on an ever-increasing basis. Some enterprises release, patch, or otherwise modify their software code dozens of times per week. Further, enterprises can maintain multiple servers to host their software applications, such as multiple web servers deployed to host a particular web application. As updates to software and new software are released, deployment of the software can involve coordinating the deployment across multiple machines in potentially multiple geographical locations.

### BRIEF SUMMARY

According to one aspect of the present disclosure, a request may be received from a particular agent at a particular one of a plurality of communication processes of an automation engine system, where the request includes a request for the particular agent to connect to the automation engine system through the particular communication process, and where the particular agent includes a particular one of a plurality of agents launched on a set of host systems, the plurality of agents are configured to perform automation actions on the set of host systems at the direction of the automation engine system, and communication between the automation engine system and the plurality of agents is to be facilitated through the plurality of communication processes. A number of connections for each of the plurality of communication processes may be determined, where the connections include respective connections between the plurality of communication processes and agents in the plurality of agents. A threshold may be identified, selected for the automation engine system, for connections between agents and the plurality of communication processes. It may be determined that connecting the particular agent to the particular communication process would cause the number of connections at the particular communication process to violate the threshold. Accordingly, the particular agent may be caused to connect to another one of the plurality of communication processes based on the determination that connecting the particular agent to the particular communication process would violate the threshold and further based on the other communication process having fewer connections than the particular communication process.

### BRIEF DESCRIPTION OF THE DRAWINGS

FIG. 1 is a simplified schematic diagram of an example computing system including an example deployment automation system in accordance with at least one embodiment;

FIG. 2 is a simplified block diagram of an example computing system including an example deployment automation engine in accordance with at least one embodiment;

FIG. 3 is a simplified block diagram illustrating an example system including multiple deployment nodes in accordance with at least one embodiment;

FIGS. 4A-4C are simplified block diagrams illustrating an example technique for assigning agent and user interface connections to communication processes within an example software automation system in accordance with at least one embodiment;

FIG. 5 is a simplified block diagram illustrating an example of rebalancing connections among communication processes within an example software automation system in accordance with at least one embodiment;

FIG. 6 is a simplified flow diagram illustrating an example technique for load balancing communication processes within an example automation engine system.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

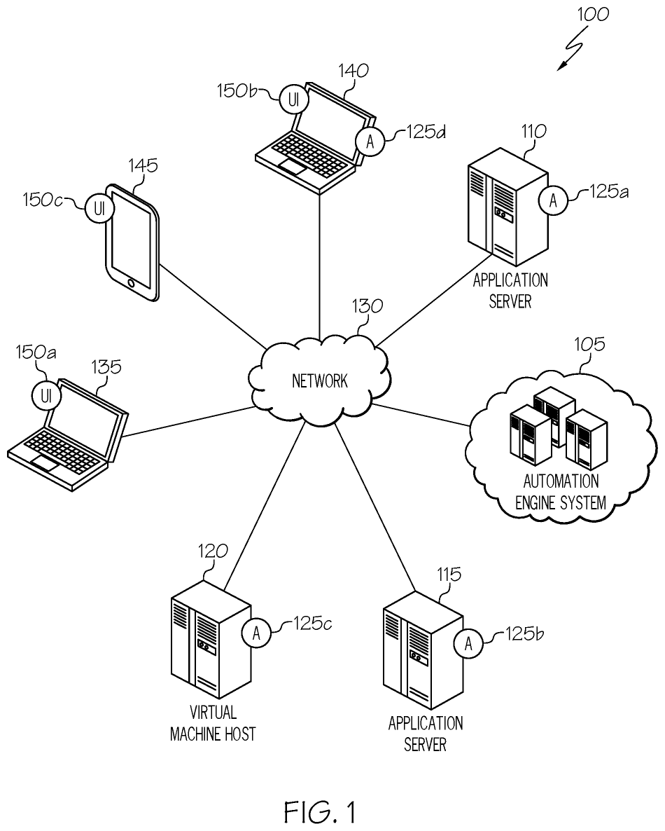

Referring now to FIG. 1, a simplified block diagram is shown illustrating an example computing environment 100 including an example automation engine system 105. The automation engine system 105 may be implemented on one or multiple host server devices and may flexibly implement a variety of software automation solutions and applications including release automation, workload automation, and automated service orchestration. An automation engine system may implement an automation engine implemented through a collection of interconnected work processes (hosted on one or more of the servers of the automation engine system 105) and communication processes (hosted on one or more the servers of the automation engine system 105). The work processes may be configurable to perform tasks to automate a variety of tasks on a computing system local to or remote from the automation engine system 105. For instance, an automation engine hosted on automation engine system 105 may automate workflows utilizing software applications, scripts, applets, or other software programs hosted on one or multiple different target computing systems, such as application server systems (e.g., 110, 115). In other instances, the automation engine may be utilized to orchestrate a service or automate the deployment and installation of a new software release on one or more of these systems (e.g., 110, 115) or other computing systems (e.g., a virtual machine or container-based host system (e.g., 120)), among other examples. Hosts and server systems may also be implemented on personal computing devices (e.g., 140), Internet of Things (IoT) devices, smart home systems, media consoles, smart appliances, and other computing systems, which may interface with an automation engine (on automation engine system 105) over one or more networks (e.g., 130) in connection with workflow automation, release automation, service orchestration, or other software automation applications supported by the automation engine.

In some implementations, agents (e.g., 125a-d) may be provisioned on host systems (e.g., 110, 115, 120, 140) to provide a hook for the automation engine to control operating system tasks or other operations and functionality provided on a host system through an operating system, hypervisor, application, or other software program, which may facilitate a workflow automation, release automation, service orchestration, or other software automation implementation. An automation engine may communicate with various agents deployed within host systems (e.g., 110, 115, 120, 140), for instance, through communication processes implementing the automation engine. In some implementations, communication processes may support and implement network communications (e.g., over one or more networks (e.g., 130)) between the computing system(s) (e.g., 105) hosting the work processes and other components of the automation engine. Further, in some implementations, user interfaces (e.g., 150a-c) may be defined in connection with the automation engine, which may be accessed on one or more user computing devices (e.g., 135, 140, 145), for instance, as a web-based or browser-implemented user interface. Users may provide inputs and define parameters for an automation implemented by the automation engine through these UIs (e.g., 150a-c). The inputs may be routed to one or more of the work processes of the automation engine using the communication processes of the automation engine, to allow for the definition of user-customized automations and even the definition of new or customized automations provided through the automation engine, among other examples.

In general, “servers,” “clients,” “computing devices,” “network elements,” “database systems,” “user devices,” and “systems,” etc. (e.g., 105, 110, 115, 120, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, zOS, etc., as well as virtual machines and emulators adapted to virtualize execution of a particular operating system, as well as container-based operating environments (e.g., Docker containers, Kubernetes containers, etc.), and customized and proprietary operating systems among other examples.

Further, servers, clients, network elements, systems, and computing devices (e.g., 105, 110, 115, 120, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an automation engine system 105, application server (e.g., 110, 115), host server 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Through the advent of cloud and distributed computing architectures, together with agile software development paradigms, the management and implementation of software systems by enterprises has become increasingly complex. For instance, as computing systems migrate to cloud or hybrid cloud environments, managing workflows and deployment of new software may be more complex and costly without information technology automation. Further, given the rapid pace of software innovation, versioning, and updates, the pace at which software is released and orchestrated has likewise increased. For instance, in the case of release automation, releases and updates may be frequent, complex, and expensive to deploy in modern software systems. Managing the potentially thousands of software releases, even relating to a single entity's (e.g., enterprise's) system, can be difficult and exact costs on the very operability of the system. Such releases include both releases of new software systems as well as updates or patches to existing software. Valuable information technology (IT) personnel and resources are dedicated within some enterprises to developing and carrying-out these deployments. Traditionally, human users are employed throughout the process of the deployment. Further, human IT resources are not only expensive, but error prone, resulting in some deployments which are incorrect and that may need to be re-deployed, further consuming time and personnel resources. Additionally, some systems may be sensitive to down periods that may be required in order to allow deployment of new software releases on the system, among other complexities, costs, and variables. Similar complexities and costs are introduced when considering the orchestration of new services, managing workflows in transactions to be handled and developed using a software system, among other example considerations.

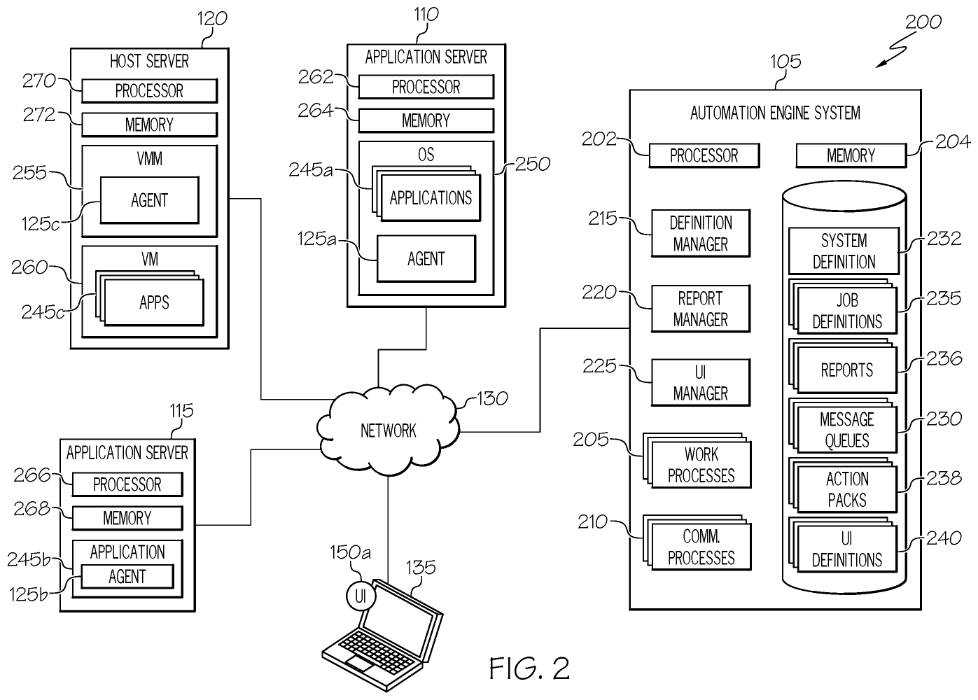

Automation tools and processes may be purpose built to handle common automation tasks, however, given the diversity and continuing evolution of enterprises' software systems, specialized, purpose-built automation tools are often ill-equipped to adapt to the ever-changing landscape of modern software products and systems. In some implementations, a flexible, scalable, and configurable automation engine may be provided, which is capable of being used, reused, and repurposed, dynamically, to provide a single automation platform capable of handling and be extended to handle a wide and diverse array of automation workloads and tasks. At least some of the systems described in the present disclosure, such as the systems of FIGS. 1 and 2, can include functionality providing at least some of the above-described features that, in some cases, at least partially address at least some of the above-discussed issues, as well as others not explicitly described.

For instance, in the example of FIG. 2, a simplified block diagram 200 is shown illustrating an example environment including an example implementation of an automation engine system 105. An automation engine implemented using the automation engine system 105 may be composed of a collection of work processes 205 and communication processes 210. Work processes (e.g., 205) are server processes implemented within the automation engine to perform the actual server work in various automations, such as activating, generating, and executing tasks within a given automation job, together with monitoring the status of the tasks and collecting information (and generating report data) relating to the completion of these tasks. Work processes 205 may retrieve tasks from a queue, with the tasks including logic executable by the work process to cause the work process to perform a particular type of task. When the work process 205 accesses a next task from the queue, it may retrieve corresponding logic and perform the next task, which may be the same or a different type of task than the work process's previously performed task. Indeed, the flexibility of the work processes allow a configurable mix of tasks and corresponding jobs to be handled by the collection of the work processes 205 in the automation engine, allowing the automation engine to respond dynamically to what may be a changing and diverse workload the automation engine is called on to handle. In other instances, work processes may be configured to be dedicated to handling particular types of high priority or low latency tasks, such that all of the work process's bandwidth is directed toward these types of tasks in the automation engine's workload (e.g., despite the work process being otherwise operable to handle potentially any one of the variety of tasks in jobs handled by the automation engine).

Further, one of the work processes implemented in the automation engine may be designated as the “primary” work process. A primary work process, in some examples, may be designated at the launch of the automation engine (e.g., based on the work process being the first to start) and this primary work process may be assigned special tasks based on its designation as the primary process, such as central work process tasks. In some cases, the primary work process may be tasked with autonomously assigning roles to additional work processes as they are started within the automation engine. In some implementations, work processes may be assigned roles to filter the types of tasks the respective work process is to handle. For instance, some work processes may be assigned (e.g., by the primary work process) to perform an output server role to handle outputs such as storing log messages and reports generated in the automation engine within a database of the automation engine. Another example server role which may be assigned to work processes may be a resource calculation role to perform tasks such as calculating calendar objects, perform deadlock avoidance, and other tasks, which involve calculations, among other examples. In some implementations, separate queues may be maintained in the automation engine database for each server role, such that tasks of a given work process are extracted from the specific queue corresponding to the work process's assigned role, among other example features and implementations.

Communication processes (e.g., 210) are additional server processes running on one or more computing systems (e.g., 105) implementing an instance of an automation engine. Communication processes 210 may handle communication between agents (e.g., 125a-c)), user interfaces (e.g., 150a), and work processes (e.g., 205) in connection with the automation engine. Communication processes hold the connections to the agents and the user interfaces. In some implementations, all communication between agents and UIs may be exclusively performed through the communication processes 210. In some implementations, port numbers of the systems hosting the automation engine may be assigned to respective work processes and communication processes. All of the server processes (e.g., work processes 205 and communication processes 210) may communicate with each other. Such an architecture can ensure flexibility and fault tolerance, allowing remaining processes to assume the queued tasks of another process in the event the other process fails, among other example features and advantages.

As noted above, a communication process can connect with agents (e.g., 125a-c) and UIs (e.g., 150a) to facilitate the communication between the agents and UIs and various work processes (e.g., 205) of an automation engine implementation. Agents may be implemented on target systems (e.g., 110, 115, 120) to expose functionality of an operating system (e.g., 250), application (e.g., 245b), virtual machine manager (e.g., 255), or other software program to the automation engine. Accordingly, agents may be implemented according to the specific features of the target software component (e.g., 245b, 250, 255, etc.). As an example, different agents may be provided for instrumentation on any one of a variety of different operating systems, such as agents specific to Windows, Linux, iOS, zOS, etc., among other examples. In some implementations, agents may initiate connections with one of the communication processes provided in an automation engine. For instance, an agent may open a TCP/IP connection with one of the communication processes of the automation engine. In some implementations, each agent may connect to a single one of the communication processes, while each communication process may be connected to multiple agents and/or user interfaces. Communications between the agent and a communication process may be encrypted.

As discussed in the examples above, a collection of work and communication processes may be provided in an automation engine system. In some cases, it may be advantageous to host the work processes 205 and communication processes 210 on multiple nodes or computing devices, as this can enhance fault tolerance of the automation engine and boost efficiency and reliability through the distribution of these processes over several computers. In some implementations, a potentially unlimited number and variety of work and communication processes may be implemented in a single automation engine instance. Further, by adding processes it is possible to adjust to growing use of the automation engine system. For instance, should a heavy workload exist or be introduced due to the number of logged-on agents and/or UIs, the number of communication processes can be increased. Likewise, should the number of automation engine system tasks become too burdensome, the number of work processes can be increased, among other example advantages.

As further illustrated in FIG. 2, an example automation engine system 105 may include one or more data processing apparatus (e.g., 202), one or more computer memory elements 204, and other components and logic, implemented in hardware circuitry and/or software to implement an automation engine instance. For instance, a definition manager 215 may be provided, through which a system definition file 232 may be accessed, modified, and/or defined. A system definition 232 may define the number of work processes 205 and communication processes 210 within an automation engine instance, as well as detail the individual computing systems hosting these server processes, the ports assigned to each process, among other information utilized to define an automation engine instance. A definition manager 215 may additionally access and/or define job definitions, which may correspond to automation jobs that may be performed by the automation engine. The job definitions 235 may additionally detail the combination of automation tasks and the target systems involved in the performance of these tasks in the furtherance of such automation jobs. Automation jobs may provide the information to be loaded into work queues consumed by work processes 205 in the automation engine. In some cases, automation jobs may be packaged in action packs (e.g., 238), which may be pre-generated packages of common types of automations, which may be reused and redeployed in various customers' respective automation engine instances. An individual instance of an automation engine may allow a user or manager to parameterize the action pack to enable the action pack's use within a particular customer's system (with its component target systems) (e.g., using definition manager 215). In some implementations, a report manager 220 may also be provided, which may enable user access to reports 236 and other data generated through the execution of various automation jobs by the automation engine (e.g., as generated by work processes 205 within the automation engine). A UI manager 225 may also be provided, in some implementations, to allow users or managers to define new UIs or parameterize UI templates for use in providing UIs (e.g., 150a) that are to interface with and be used in connection with automation jobs performed by an automation engine deployment. UI definitions 240 may be generated and maintained by the automation engine system 105 to form the basis of these UIs (e.g., which may be presented through web- or browser-based interfaces on potentially any user endpoint device (e.g., 135) capable of connecting to the automation engine over a private or public network (e.g., 130)).

In some implementations, communication between server processes of an automation engine (e.g., its component work processes 205 and communication processes 210)) may be facilitated through message queues 230. Message queues (as well as other data used to implement an automation engine instance (e.g., 232, 235, 236, 240, etc.)) may be hosted in a database implemented in connection with the automation engine and hosted on one of the computing systems of automation engine system 105. Message queues (e.g., 230) may be implemented as database tables, through which a work or communication process may post a message that may then be read and processed by another work or communication process, thereby facilitating communication between the processes. Additional queues may also be provided which contain the tasks that are to be accessed by server processes and performed in connection with an automation engine implementation. In some implementations, an automation engine instance may have multiple message queues. Depending on their types, tasks are lined up in the corresponding queue. If a work process is momentarily idle or finished with its current tasks, it will take the next queued task and process it. The execution of the task can lead to a new task for the work queue to be then attached to the current tasks. Some tasks may be dedicated tasks, which are allowed to only be processed by the primary work process. Accordingly, in such implementations, a primary work process, upon completing a preceding task, may first check (in a corresponding queue) whether any special work tasks are waiting in the queue before turning to more general work queues for generally work tasks shared with the other work processes. or this reason, the “freed-up” primary work process always checks first if any of these special work processes are present in the queue. Communication processes may utilize communication queues for communication tasks to be performed by communication processes to collect or send data from/to agents and/or UIs associated with the automation engine. In some instances, if a work process tasks involves the passing of information to agents or UIs, the work process may, as part of the performance of its task, write a new communication queue to the respective communication queue in order to prompt the communication process's involvement in the passing of this information, among other examples.

As noted above, an automation engine provided through an automation engine system 105 may be used to automate activities on various target systems (e.g., 110, 115, 120). For instance, application servers (e.g., 110, 115) hosting various applications and other software tools and programs (e.g., 245a-b) may be target systems of an automation engine. For instance, tasks automated by an automation engine may automate deployment of a new or updated version of an application or system of interoperating programs on one or more computing systems (e.g., 110, 115, 120). In other examples, a workflow involving one or more multiple different cooperating applications (e.g., 245a-c) may be automated may be automated using an automation engine, among other examples. The automation engine may interface with agents to cause functionality present on the target system to be triggered and automated according to defined automation engine tasks and jobs. In some instances, agents (e.g., 125a) may be present on an operating system (e.g., 250) of the host system (e.g., 110), on which a target application (e.g., 245a) runs. In other instances, the agent (e.g., 125b) may be present on the application (e.g., 245b) itself. During the automation of a workflow, the automation engine may communicate with and cause actions to be performed on multiple different applications (e.g., 245a-c) and host systems (e.g., 110, 115, 120) through corresponding agents (e.g., 125a-c). In automation jobs involving service orchestration or release automation, agents (e.g., 125a, c) may be used to access functionality and resources of the system that are used to deploy, install, configure, load, or otherwise automate deployment or installation of a program on one or more target systems. As an example, an application may be automatically deployed on a virtual machine using an example automation engine, through the automation engine's communication with an agent (e.g., 125c) provided on a virtual machine manager (VMM) or hypervisor (e.g., 255) that is to automatically build the host virtual machine (e.g., 260) upon which the application (e.g., 245c) is to be installed and run at the direction of the automation engine, among other examples.

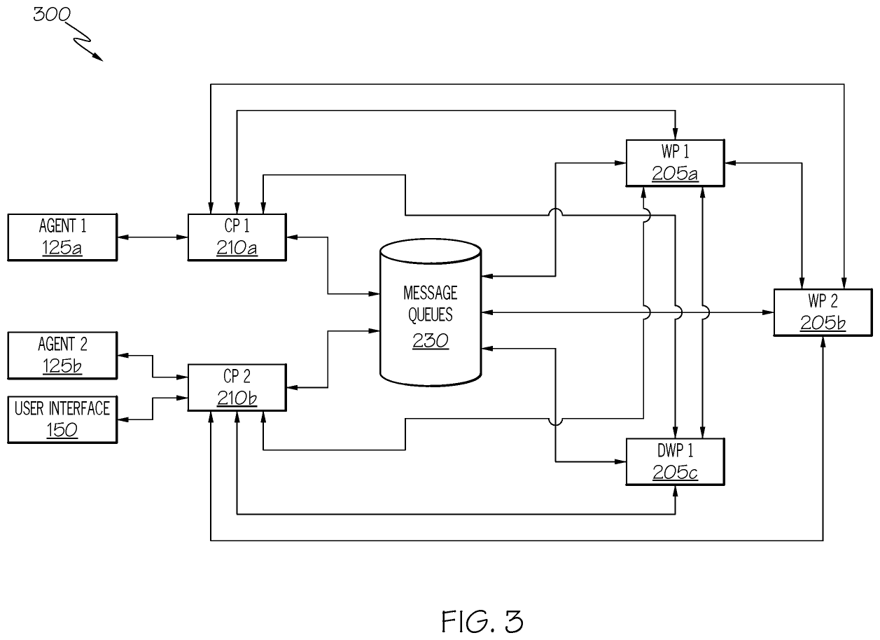

Turning to FIG. 3, a simplified block diagram 300 is shown illustrating an example automation engine implementation. In this simplified example, the automation engine may be implemented through work processes 205a-c, communication processes 210a-b, and a database hosting automation engine information including tables implementing message queues (e.g., 230) of the automation engine. In this example, work process 205a may be designated as the primary work process and may connect with and oversee the launch of the other work processes (e.g., 205b-c) in the automation engine. One or more of the work processes (e.g., 205c) may be a dedicated work process, dedicated to performing a particular type of task (e.g., a dialogue work process (DWP) specifically for use in handling UI messages (e.g., from UI 150)), while other work processes (e.g., 205b) are general purpose work processes, which may be utilized to handle potentially any type of work task to be performed in the automation engine. Each work process (e.g., 205a-c) may interface with one or more message queue tables to obtain new tasks for execution and/or communicate messages with other work processes or communication processes in the automation engine. Likewise, communication processes (e.g., 210a-b) may interface with message queues 230. Some message queues may be dedicated message queues, reserved for a particular subset of the server processes (e.g., 205a-c, 210a-b) in the automation engine, while other queues may be provided for access and use by potentially any one of the automation engine server processes. Each communication process (e.g., 210a-b) may be connected to one or more agents (e.g., 125a-b) and/or one or more UIs (e.g., 150) provided for interfacing with the automation engine. Agents (e.g., 125a-b) may expose functionality of a target system for use by the automation engine. UIs may be provided to enable users to submit information for use by the automation engine and/or to present information (e.g., prompts, results, status updates, etc.) generated by the automation engine to the user, among other examples.

It should be appreciated that an automation engine may include any potential number of one or more work processes and communication processes. As the workload to be handled by the automation engine or the general complexity of the automation engine implementation increases, additional work and/or communication processes and corresponding message queue tables may be added to expand the bandwidth and flexibility of the automation engine. Likewise, the scale and scope of an automation engine may also be reduced, by removing work and/or communication processes, among other examples. As an illustrative example of a job, which may be performed by an example automation engine, a workflow involving an example customer relationship management (CRM) platform may be automated using an example automation engine, such as shown in the example of FIG. 3. Jobs may be defined, which are designed to automate the generation of social media promotions (e.g., handled by a first target system) based on events detected using a second target system (e.g., a system that can forecast or detect weather patterns and/or predict foot traffic within a retail establishment, etc.).

In one example, when certain weather conditions are detected or predicted, an example workflow can cause a social media management system to automatically generate a promotional posting on one or more social media platforms to promote an offering appropriate for the detected weather (e.g., an ice cream promotion on a hot day). For instance, a first one of the work processes (e.g., 205b) may perform a task to cause a weather forecast to be performed using a first target system. The performance of this task may involve causing a communication process (e.g., 210a) interfacing with the target system through a corresponding agent (e.g., 125a) to send a communication to the agent to engage with the target system and cause the target system to generate forecast data. This forecast data may be passed back to the automation engine by the agent 125 through the communication process 210a, and the forecast data may be provided to a message queue and cause a task to be performed by one of the work processes to access and process the forecast data returned from the target system. For instance, work process 205a may be free to handle the task of processing the forecast data, with the task involving determining a weather event from the forecast data. In one example, a work process 205a may determine that the forecast data evidences a warm weather event. The detection of a warm weather event may cause a task to be queued to trigger the social media promotion on a social media system. The workflow definition may embody the logic, executed by the work processes to determine an action, result, or next task to execute based on results of the preceding task. In one example, a free work process may access the queued task and communicate an instruction to launch the social media promotion through a communication process (e.g., 210b) interfacing with the social media system through a corresponding agent (e.g., 125b), among other example implementations and use cases. Indeed, it should be appreciated that potentially any combination of the provided work processes (e.g., 205a-c) in the automation engine may perform various tasks within a single automation job (e.g., a workflow automation job, service orchestration job, release automation job, etc.) based on the availability of the various work processes. Further, an automation engine may simultaneously handle multiple different automation jobs using the same collection of work processes and communication processes 210a-b, balancing work of the multiple jobs between the collection of processes in the automation engine, among other example implementations.

In some implementations, when an agent is launched on a particular target or host system for operation with a particular automation engine, the agent may attempt to identify and connect to the automation engine through one of the communication processes provided in the automation engine. For instance, a service manager utility present on a particular host computer may select a particular agent implementation and designate this agent for use with a particular one of potentially many different automation engines. The agent, too, may be selected from one of potentially many different agent implementations offering various functionality and/or compatibility with various different operating system, software containers, applications, and the like. The service manager may then cause the agent to be loaded and run on the particular host machine. In some implementations, without a connection to a communication process of the selected particular automation engine, the agent is unable to interface and operate with the particular automation engine.

In some implementations, an automation engine platform may attempt to load balance the work performed by the communication processes implemented in the automation engine, such that each communication process handle a substantially comparable load, providing connections to relatively similar numbers of agents and user interfaces hosted on various host systems to the automation engine. In some implementations, an agent, upon launch, may identify a collection of communication processes for the selected automation engine it is to interface with. For instance, the collection of communication processes may be communicated and maintained at the service manager or may be obtained by an agent in a preceding connection with the automation engine or accessed from a local record stored in memory of the host, among other example implementations. s associated with an agent.

In one example, the agent may individually query each of the communication processes in the automation engine to identify how many connections (to other agents and UIs) each communication process has. Accordingly, each communication process may independently maintain a record counting the number of connections between the communication process and various agents and UIs interfacing with the automation engine. The queried communication processes may return results to the agent to allow the agent to determine, after contacting each of the communication processes of the automation engine, which of the queried communication processes has the fewest connections. In some instances, the agent may request a connection to the automation engine through the communication process with the lowest current number of connections. While this approach may guarantee that the newly activated agent selects the most available one of the communication processes to connect to the automation engine, such an approach may suffer from the disadvantage of relatively high latency and inefficient use of processing and network resources implementing the agents and automation engine, by virtue of each of potentially thousands of agents querying each of potentially many communication processes any time the agent is reactivated (e.g., after an upgrade, host system reboot, etc.). This may become particular problematic in instances of mass restarts of multiple agents, each competing to query the collection of communication processes substantially concurrently in order to reconnect to the automation engine.

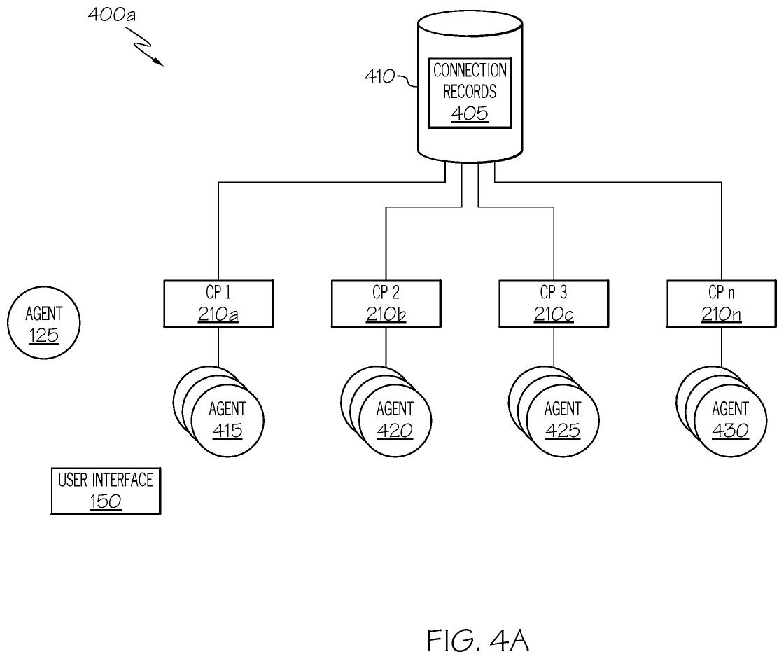

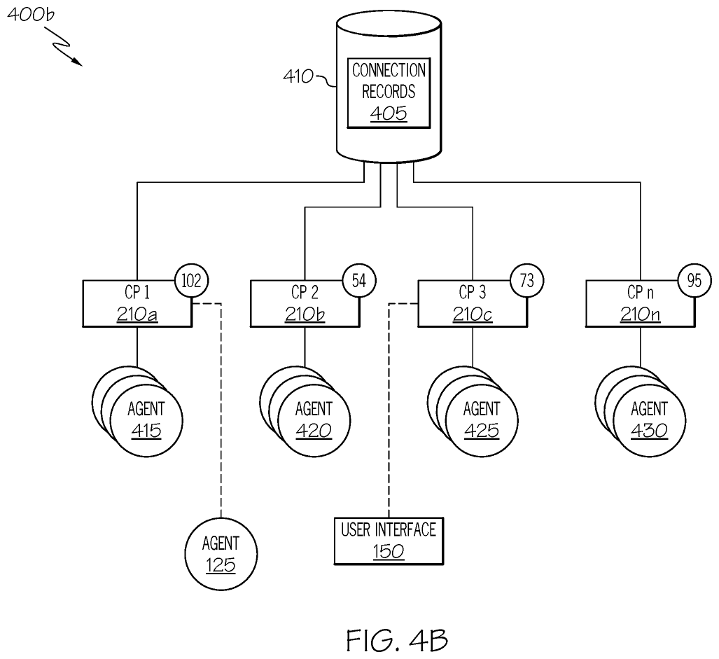

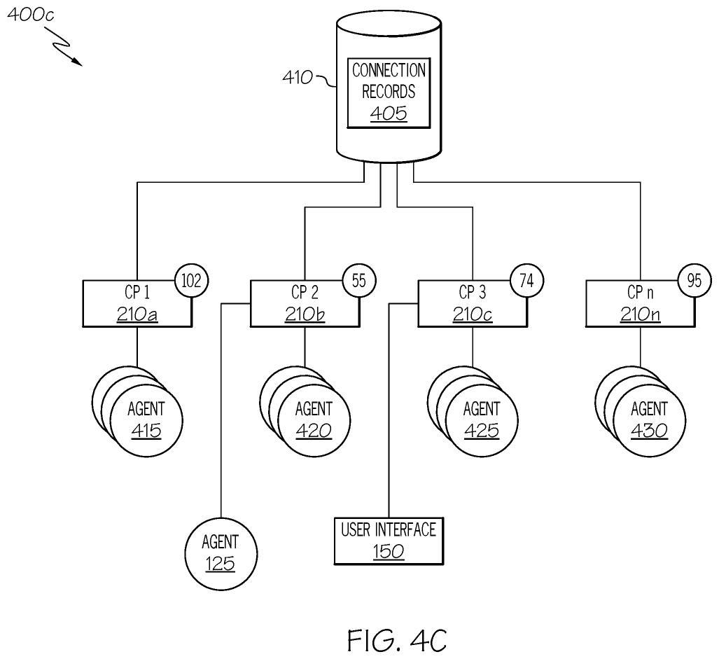

Some implementations may remedy at least some of the issues above. Turning to the simplified block diagrams 400a-c of FIGS. 4A-4C, an implementation of an automation engine system is illustrating, showing an alternate solution to balancing agent/UI connection with communication processes (CP) of an automation engine. As shown in FIG. 4A, a number of agents and UIs (shown collectively as agent collections 415, 420, 425, 430) may each connect to one of the communication processes (e.g., 210a-n) of an automation engine instance. The communication processes (e.g., 210a-n) may establish network communications for each of their connected agents and UIs to enable other processes of the automation engine to communicate (i.e., send and receive data) with the agents connected through the communication process. For instance, work processes of the automation engine may send data to cause automation actions to be performed by the agents on their respective target systems and data to be presented on various UIs in accordance with various automation workflows defined through the automation engine. Likewise, agents may send data reporting results or progress of actions performed at the agent and UIs may return user-generated data provided at the UIs to the automation engine for processing (e.g., using various work processes in accordance with workflows defined in the automation engine).

In the example of FIGS. 4A-4C, an automation engine database 410 may be provided and maintain connection records 405 to centrally track in real time, for all of the communication processes 210a-n implemented in the automation engine, the number of agent and UI connections at each communication process. The database 410 may be the same automation engine database used to store work/job definitions, implement message queues in the automation engine, store upgrade packages, action packs, UI definitions, and other data and code utilized to implement the automation engine (such as discussed in the example of FIG. 2 above).

In FIG. 4A, a particular agent 125 and/or a particular UI 150 have been recently activated on their respective host machines and are ready to connect to a selected automation engine (i.e., including communication processes 210a-n). In one example implementation, the agent 125 or UI 150 may identify the communication processes 210a-n that are currently running in the automation engine. As the automation engine may dynamically activate additional communication processes or deactivate/close previously run communication processes, the set of communication processes available in the automation engine may change over time. The agent 125 or UI 150 may then randomly select one of the identified communication processes 210a-n. For instance, turning to FIG. 4B, upon randomly selecting one of the communication processes (e.g., agent 125 randomly selecting communication process 210a and UI 150 randomly selecting communication process 210c), the agent/UI may send a request to connect to the randomly selected communication process. The communication process (e.g., 210a, 210c) upon receiving the request to connect, may query the connection records 405 of the automation engine database 410 to obtain a record identifying the current number of connections at each of the communication processes 210a-n within the automation engine. In some cases, rather than querying the database 410 at each connection request, a communication process may maintain a local cached copy of the connection record information (e.g., until an expiration period requiring a new copy of the connection record information to be obtained by the communication process (e.g., on a next connection request)). The communication process may assess the connection numbers of each of the communication processes and identify whether the number of its connections are high relatively to the current connections at the other communication processes. If the variance in connection numbers is within an allowed threshold, the requested communication process (e.g., 210a) may conclude that it can accept another connection (e.g., from agent 125) in response to the request. However, if accepting this new connection would exacerbate the variance in connection numbers between communication processes, the communication process may reject the connection request and identify, from the connection record information, a better candidate communication process for the requesting agent/UI to connect to.

In one example implementation, a threshold may be defined in the automation engine corresponding to the maximum permissible difference in the number of connections between communication processes. For instance, if a requested communication process (e.g., 210a) receives a request (e.g., from agent 125), and the difference in the current number of connections at the requested communication process (e.g., 102 connections) is higher than the number of connections at the communication process (e.g., 210b) having the lowest number of current connections (e.g., 54 connections) in the automation engine, the communication process may refuse the connection request and affirmatively act to cause the agent/UI to connect to either the communication process with the lowest connection count or another communication process where the addition of a new connection would not violate the defined threshold. For instance, the dismissing communication process may return the identifier of the other communication process to the agent/UI as an instruction to cause the agent/UI to connect to the other communication process, or may reroute the request directly to the other communication process to cause the connection with the other communication process to be completed. In one example implementation, a communication process may return either a connection confirmation response or a negative return code in response to a connection request by an agent, with the negative return code including an identifier of another one of the communication processes possessing more bandwidth for handling the connection with the requesting agent, among other example implementations.

By way of illustration, and continuing with the example of FIGS. 4A-4C, a threshold may be defined to specify a particular number of connections, a threshold percentage, a threshold variance, a threshold standard deviation, or another threshold value, which communication processes may use to determine whether or not to accept a new agent/UI connection request. For instance, a threshold may be defined for an automation engine (and may be adjusted dynamically or manually over time to the design of the corresponding automation engine), such as a threshold number of 30 connections or a threshold percentage of 40%, among other examples, to define a maximum desired difference in connections between communication processes. In this example, at a particular moment in time, a first communication process 210a may have 102 connections, a second communication process 210b may have 54 connections, a third communication process 210c may have 73 connections, and an n^{th} communication process 210n may have 95 connections, and so on. Connection records 405 maintained in database 410 may indicate, for each communication process 210a-n, the number of current connections. In this example, at this particular window of time, communication process 210b may be identified as having the fewest current connections, although the communication process with the fewest connections may change over time within an automation instance.

Continuing with the example of FIG. 4B, a newly activate agent 125 may randomly select one of the communication processes (e.g., 210a) and request a connection to the automation engine through the communication process 210a. In response, the requested communication process 210a may query the database 410 to determine the current number of connections at each of the communication processes of the automation engine. In so doing, the communication process 210a may identify that communication process 210b has the fewest number of connections and may determine whether its number of connections (e.g., 102 connections) exceeds the number of connections of communication process 210b beyond the defined threshold defined for the automation engine. Accordingly, the requested communication process 210a may access the defined threshold value for the automation engine (e.g., stored in database 410 or stored locally at the communication process) and, in this example, determine that its number of connection exceeds the defined threshold. As a result of this determination, the communication process 210a may unilaterally and autonomously initiate an alternate connection for the requesting agent 125 that would result in a new, additional connection at another communication process that would not result in a violation of the defined threshold. In one example, the requested communication process 210a may decline the connection request and direct the requesting agent 125 to connect to the communication process (e.g., 210b) identified by the communication process 210b as having the lowest current number of connections in response to the agent's 125 connection request. In other implementations, the requested (and declining) communication process 210a may select another one of the communication processes (other than the communication process (e.g., 210b) with the lowest connection count that would satisfy the threshold, such as by identifying all other communication processes (e.g., 210b-c) that likewise would not violate the threshold through an additional connection and then randomly selecting a communication process from this subset, selecting one of these communication processes on a round-robin basis, selecting one of these communication processes based on a rule or algorithm (e.g., favoring the communication processes on the same or proximate host systems as the requesting agent), among other considerations and implementations.

Turning briefly to FIG. 4C, in the above example, the requested communication process 210a determines that it cannot accept the connection request of agent 125 and in turn directs and causes the agent 125 to instead connection to communication process 210b, based on compliance with the defined threshold difference for the automation engine. Accordingly, the connection record (e.g., 405) for the communication process 210b may be updated to reflect the addition of the new connection with agent 125.

Returning to FIG. 4B, as noted above, in this example, a second connection request by another agent or UI (in this case UI 150) may be made at or near the time of the request by agent 125. In this case, UI 150 randomly selects communication process 210c to submit its initial connection request (illustrated by the dashed line in FIG. 4B). As in the example above, communication process 210c may access connection records 405 for the automation engine and determine that one or more other communication processes have a lower number of connections and/or identify a particular one of the communication processes (e.g., 210b) having the current, lowest number of connections among the communication processes (e.g., 210a-n) of the automation engine. The requested communication process (e.g., 210c) may then determine whether adding another connection to its number of connections, would cause the communication process to violate a defined threshold corresponding to a difference in the number of connections between communication processes in the automation engine. In this particular example, the communication process 210c may identify that its number of connections (e.g., 73 connections) is higher than other communication processes in the automation engine (e.g., higher than the 54 connections at communication process 210b), but may nonetheless determine that adding another connection would not cause the difference in the number of connections between communication process 210c and one or more other communication processes to rise above a defined threshold level. Accordingly, the requested communication process 210c may accept the connection request from UI 150 (as shown in FIG. 4C), and the connection records may be updated accordingly. This process may repeat as any agent or UI is made active and attempts to connect to an automation engine and may enable connection requests (and in particular multiple substantially simultaneous connection requests) to be handled in a balanced manner with minimal superfluous connections and communications between agents and communication process during the setting up of connections between these agents/UIs and the automation engine, among other example advantages.

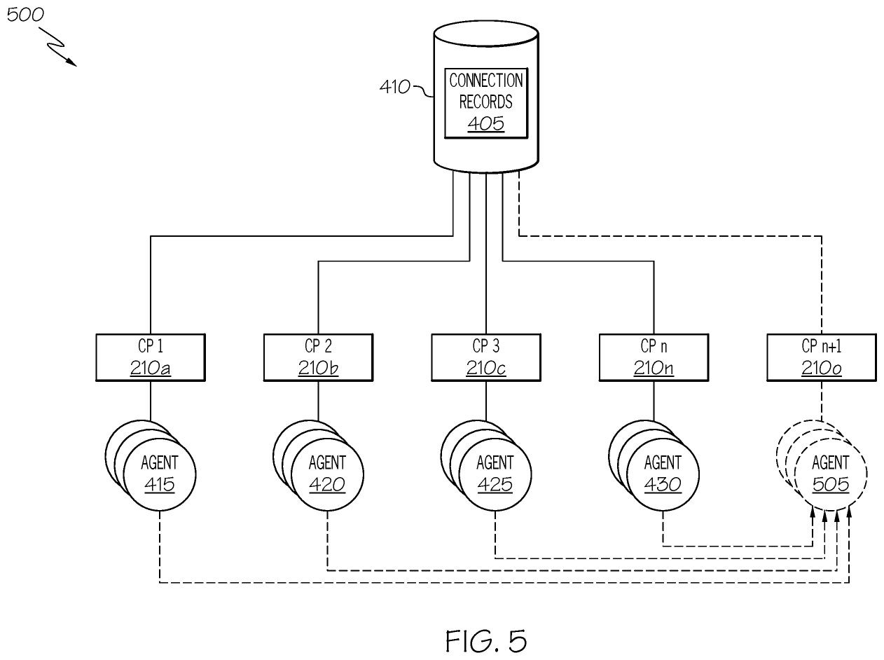

Turning to the example of FIG. 5, as noted above, not only can agents and UIs be brought up and down within an automation engine system, affecting the load balancing of connections between agents/UIs and communication processes (e.g., as discussed above), but the number of communication processes may change before and during runtime of the automation engine. For instance, FIG. 5 is a simplified block diagram 500 illustrating an example involving a change in the number of communication processes within an automation engine system. For instance, in the example of FIG. 5, one or more new communication processes (e.g., 2100) may be launched for the particular automation engine. In other examples, the pool of communication processes of an automation engine may decrease through the deactivation of one or more communication processes. In some implementations, in response to the addition or subtraction of a communication process from an automation engine, the automation engine (e.g., at the collection of the communication processes themselves, or through centralized automation engine management logic) may operate to at least partially rebalance the load of connections with agents/UIs and each of the respective communication processes. For instance, rebalancing may be performed so as to redistribute connections based on a change in the number of communication processes based on the host computer hosting the communication processes and/or agents (e.g., with agents/UI hosted on the same host or nearby host as the communication process having preference), based on an activity level of the agent/UI (e.g., with more active agents/UIs remaining with their connected communication process to avoid disruption to the system), among other considerations and algorithms.

In one example, in connection with the addition of a new communication process, in some cases, no rebalancing may be performed, such as when the number of connections of the existing communication processes is below a certain threshold level (e.g., based on an assumption that the new communication process may “catch up” quickly with the other communication processes using the load balancing techniques discussed above). Indeed, in some implementations, the addition of a new communication process to the collection of communication processes of an automation engine may result in all new connection requests being handled by the new communication process until a load balancing threshold is reached. However, if the number of connections at the existing communications processes is above this threshold, representing a more significant imbalance between the new communication process's and the existing communication processes' respective loads, some rebalancing may be performed (e.g., to bridge the gap to within a threshold level). This rebalancing, such as illustrated in FIG. 5, with communication processes 210a-210n giving up some connections with their respective agents (e.g., 405-430) to cause some of these agents to reconnect through the new communication process 210a (and form a new collection of agents 505 connected to the automation engine through the new communication process 2100), may be implemented to minimize disruption of the agents and their connections. For instance, rather than reassigning a number of existing connections to the new communication process to substantially equalize the number of connections at each of the communication processes, a minimum number of connections may instead be reassigned, to preserve as many of the existing connections as possible. This may result in the new communication process having a significantly lower number of connections than the other communication processes, but a sufficiently high number of connections to nonetheless safeguard against the possibility that a mass activation of multiple agents would all be load balanced to result in all the new connection requests being redirected to the new communication process (e.g., according to the algorithm discussed in the examples of FIGS. 4A-4C) at substantially the same time (introducing increased latency to the connection process). In other cases, this may of lesser concern, and a new communication process may simply be reassigned a number of connections to place the number of connections within a threshold defined for the connection load balancing algorithm applied in the automation engine, among other example implementations.

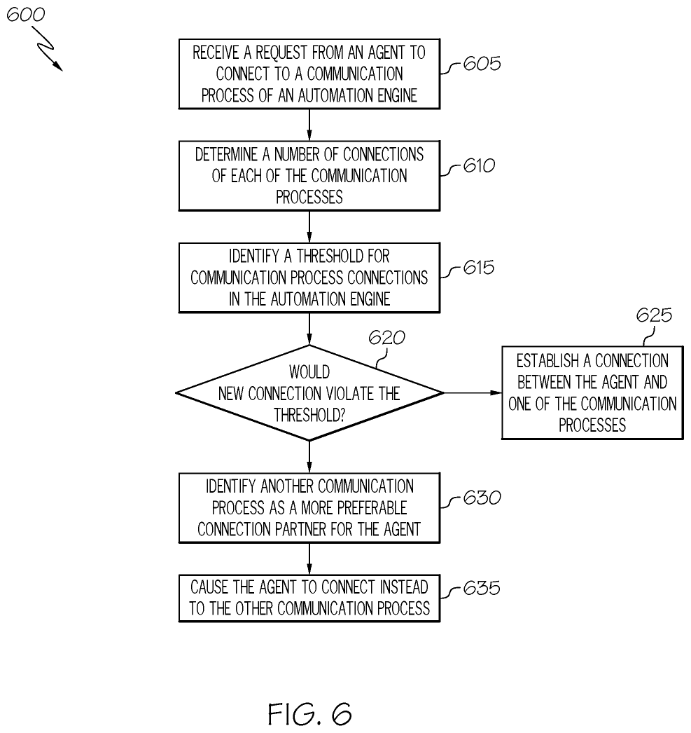

FIG. 6 is a simplified flowchart 600 illustrating an example technique for load balancing communication processes within an example automation engine system. For instance, a request may be received 605 at a particular one of numerous communication processes implemented in an automation engine, from an agent (or UI) to connect to the particular communication process in connection with the agent (or UI) functioning with the automation engine. In response to the request to connect (at 605), the particular communication process may determine 610, autonomously, the number of connections it has to agents and UIs (e.g., in aggregate), as well as the number of connections of each of the other communication processes in the same automation engine instance. The particular communication process may identify 615 a threshold set for the automation engine, which governs whether the particular communication process can accept new connection requests in association with a connection load balancing scheme applied within the automation engine. The particular communication process can evaluate the determined numbers of connections based on the threshold and determine 620 whether accepting the connection request would cause the number of connections of the particular communication process to violate the identified threshold value. Determining that accepting the connection would not violate the threshold results in the particular communication process accepting the request and connecting to the requesting agent (or UI). Determining that the new connection would cause the particular communication process to violate the threshold causes the particular communication process to identify 630 another one of the communication processes as a candidate for the connection, based on the addition of this new connection not violating the threshold when added to the existing connections of the other communication process. The particular communication process may then initiate or cause 635 the requesting agent (or UI) process to instead connect to this other communication process as a response to the request received (at 605) from the agent (or UI), among other example implementations and features.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving a request from a particular agent at a particular one of a plurality of communication processes of an automation engine system, wherein the request comprises a request for the particular agent to connect to the automation engine system through the particular communication process, wherein the particular agent comprises a particular one of a plurality of agents launched on a set of host systems, the plurality of agents are configured to perform automation actions on the set of host systems at the direction of the automation engine system, and communication between the automation engine system and the plurality of agents is facilitated through the plurality of communication processes;
determining a number of connections for each of the plurality of communication processes, wherein the connections comprise respective connections between the plurality of communication processes and agents in the plurality of agents;
identifying a threshold, configured for the automation engine system, for connections between agents and the plurality of communication processes;
determining that connecting the particular agent to the particular communication process would cause the number of connections at the particular communication process to violate the threshold; and
causing the particular agent to connect to another one of the plurality of communication processes based on determining that connecting the particular agent to the particular communication process would violate the threshold and further based on the other communication process having fewer connections than the particular communication process.

2. The method of claim 1, further comprising sending a response from the particular communication process to the particular agent, wherein the response directs the particular agent to the other communication process and causes the particular agent to connect to the other communication process.

3. The method of claim 1, wherein the request comprises an initial request of one of the plurality of communication processes by the particular agent, and the request is sent in association with activation of the particular agent.

4. The method of claim 1, wherein the automation engine comprises a set of work processes, the set of work processes are to direct the automation actions performed by the particular agent, and the work processes communicate with the particular agent through the other communication process.

5. The method of claim 1, wherein the automation actions are associated with a set of automation workflows implemented using the automation engine system.

6. The method of claim 5, wherein the set of automation workflows comprises one or more of release automation workflows, workload automation workflows, and service orchestration workflows.

7. The method of claim 1, wherein communication processes are to connect to an agent in response to a request from the agent to connect to the communication process when adding the connection with the agent to the connections of the communication process would not violate the threshold.

8. The method of claim 1, wherein the particular agent is to send the request to the particular communication process based on a random selection of the particular communication process from the plurality of communication processes by the particular agent.

9. The method of claim 1, wherein the number of connections for each of the plurality of communication processes is maintained in a database of the automation engine system, and determining the number of connections of each of the plurality of communication processes comprises the particular communication process querying the database.

10. The method of claim 9, wherein the number of connections for the other communication process is automatically updated in the database based on the connection with the particular agent.

11. The method of claim 1, wherein the threshold comprises a maximum allowed difference between the number of connections at a requested communication process and the number of connections at another communication process with the lowest number of connections in the plurality of communication processes, wherein determining that connecting the particular agent to the particular communication process would cause the number of connections at the particular communication process to violate the threshold comprises determining that the difference between the number of connections involving the particular communication process and the number of connections involving the other communication process exceeds the difference.

12. The method of claim 1, wherein each of the plurality of communication processes is to implement a respective network connection for each one of a set of agents to be connected to the automation engine.

13. The method of claim 1, wherein each of the plurality of agents is configured to run on a respective operating system and enables performance of the automation actions utilizing resources of the corresponding operating system.

14. The method of claim 13, wherein the plurality of agents comprise different agents configured to run on a plurality of different operating systems in the set of host systems.

15. The method of claim 1, wherein the number of connections comprise respective connections between the corresponding communication processes and user interfaces provided on various host systems to enable users to interface with the automation engine system.

16. A non-transitory computer readable medium having program instructions stored therein, wherein the program instructions are executable by a computer system to perform operations comprising:
receiving a request from a particular agent at a particular one of a plurality of communication processes of an automation engine system, wherein the request comprises a request for the particular agent to connect to the particular communication process, the particular agent comprises a particular one of a plurality of agents launched on a set of host systems, the plurality of agents are configured to perform automation actions on the set of host systems at the direction of the automation engine system, and communication between the automation engine system and the plurality of agents is facilitated through the plurality of communication processes;
determining a number of connections for each of the plurality of communication processes, wherein the connections comprise connections between the plurality of communication processes and agents in the plurality of agents or user interfaces hosted on the set of host systems to enable users to interface with the automation engine system;
determining that the number of connections at the particular communication process is greater than the number of connections of another one of the plurality of communication processes by a value exceeding a defined threshold for the automation engine system; and
sending data from the particular communication process to the particular agent to cause the particular agent to connect to the other communication processes based on determining that the value exceeds the defined threshold.

17. A system comprising:
a plurality of agents; and
an automation engine system comprising a database, a set of work processes, and a plurality of communication processes, wherein the work processes communicate with the plurality of agents through the plurality of communication processes, and at least a particular one of the plurality of communication processes is to:
receive a request from a particular one of the plurality of agents to connect to the automation engine system through the particular communication process, wherein the plurality of agents are configured to perform automation actions on respective host systems at the direction of the automation engine system;
determine, responsive to the request, a number of connections for each of the plurality of communication processes, wherein the connections comprise connections between the plurality of communication processes and agents in the plurality of agents;
identify a threshold value defined for the automation engine system;
determine that the number of connections to the particular communication process is greater than the number of connections to another one of the plurality of communication processes by a value exceeding the threshold value; and
cause the particular agent, responsive to the request, to connect to the other communication processes based on determining that the value exceeds the defined threshold value.

18. The system of claim 17, wherein the automation engine system further comprises a database, the database facilitates communication between work processes and communication processes in the automation engine system, and the database further comprises records of the number of connections of each of the plurality of communication processes, wherein the number of connections for each of the plurality of communications processes is determined from the records in the database.

19. The system of claim 17, further comprising a set of user interfaces hosted on one or more of the host systems, wherein the user interfaces enable users to interface with the automation engine system, the user interfaces connect to the automation engine through respective communication processes in the plurality of communication processes, and the numbers of connections include connections between corresponding communication processes and user interfaces in the set of user interfaces.

20. The system of claim 17, wherein the automation actions comprise actions to perform one of release automation, workload automation, or service orchestration on a target computing system.
